(19) United States
(12) Patent Application Publication
(10) Pub. No.: US 2026/0019855 A1
(43) Pub. Date: Jan. 15, 2026

(54) METHOD AND DEVICE FOR TRANSMITTING INDICATION INFORMATION

(71) Applicant: Beijing Xiaomi Mobile Software Co., Ltd., Beijing (CN)

(72) Inventor: Xuhua TAO, Beijing (CN)

(73) Assignee: Beijing Xiaomi Mobile Software Co., Ltd., Beijing (CN)

(21) Appl. No.: 19/113,728

(22) PCT Filed: Sep. 22, 2022
(86) PCT No.: PCT/CN2022/120454

§ 371 Date: Mar. 20, 2025

(51) Int. Cl. H04W 24/10

(52) U.S. Cl. CPC H04W 24/10

(57) ABSTRACT

A method and system for managing measurement gaps in a wireless communication network. A network device transmits first indication information to a user equipment (UE) to indicate that an association between a measurement object and a measurement gap may be modified. Upon receiving the first indication information, the UE may send second indication information specifying a type of measurement object for which the association should be changed or indicating a modification of an associated measurement gap. The network device may then transmit third indication information to the UE to confirm the change, including details such as a transition to a deactivated state for the prior measurement gap. The system also includes network and communication devices with memory and processors configured to execute the described methods. These techniques enhance flexibility in measurement gap allocation, improving network efficiency and user experience in dynamic wireless environments.

### CROSS-REFERENCE TO RELATED APPLICATIONS

The present application is a U.S. National Stage of International Application No. PCT/CN2022/120454 filed on Sep. 22, 2022, the entire contents of which are incorporated herein by reference for all purposes.

### TECHNICAL FIELD

The present disclosure relates to the field of wireless communication technology, and in particular, to a method and device for transmitting indication information and a readable storage medium.

### BACKGROUND

In a wireless communication system, a user equipment (UE) performs mobility measurement on a to-be-measured neighbor cell signal configured by a network device and reports a measurement result. The network device performs mobility management on the UE based on the measurement result. The UE suspends data transmission with a servicing cell during the measurement of the neighbor cell signal, and resumes the communication with the servicing cell after the measurement is completed. A time interval during which the UE suspends the communication with the servicing cell to measure the neighbor cell signal is known as a measurement gap (MG).

The 5G new radio (NR) introduces three types of MGs, for example, a concurrent measurement gap, a pre-configured measurement gap (Pre-MG) and a network controlled small gap (NCSG).

### SUMMARY

The present disclosure provides a method and device for transmitting indication information and a readable storage medium.

In a first aspect, the present disclosure provides a method for sending indication information performed by a network device, including:
sending first indication information to a user equipment, the first indication information being configured to indicate that an association between a measurement object and a measurement gap is allowed to be changed.

In some possible implementations, the method further includes:
receiving second indication information sent by the user equipment, the second indication information being configured to indicate the measurement object with the association to be changed.

In some possible implementations, the method further includes:
receiving second indication information sent by the user equipment, the second indication information being configured to indicate changing of a first measurement gap associated with a first type of measurement objects to a second measurement gap.

In some possible implementations, the method further includes:
sending third indication information to the user equipment, the third indication information being configured to indicate changing of a first measurement gap associated with a first type of measurement objects to a second measurement gap.

In some possible implementations, the third indication information is configured to indicate that a state of the first measurement gap is a de-activated state.

In some possible implementations, the first type of measurement objects is a measurement object requiring the measurement gap.

In some possible implementations, the first measurement gap is a pre-configured measurement gap.

In some possible implementations, sending the first indication information to the user equipment includes:
sending wireless resource control (RRC) signaling to the user equipment, the RRC signaling including the first indication information.

In some possible implementations, sending the first indication information to the user equipment includes:
sending the first indication information to the user equipment in response to a triggering event, the triggering event being configured to trigger reselection of an activated or de-activated state of the measurement gap.

In some possible implementations, the method further includes:
performing scheduling based on the measurement gap with the association changed.

In a second aspect, the present disclosure provides a method for receiving indication

information performed by a user equipment, including:
receiving first indication information sent by a network device, the first indication information being configured to indicate that an association between a measurement object and a measurement gap is allowed to be changed.

In some possible implementations, the method further includes:
sending second indication information to the network device in response to receiving the first indication information, the second indication information being configured to indicate a measurement object with the association to be changed, or to indicate changing of a first measurement gap associated with the first type of measurement objects to a second measurement gap.

In some possible implementations, sending the second indication information to the network device includes one of:
sending RRC signaling to the network device, the RRC signaling including the second indication information;
sending media access control (MAC) signaling to the network device, the MAC signaling including the second indication information; or
sending uplink control information (UCI) to the network device, the UCI including the second indication information.

In some possible implementations, the method further includes:
receiving third indication information sent by the network device, the third indication information being configured to indicate changing of the first measurement gap associated with the first type of measurement objects to the second measurement gap.

In some possible implementations, the third indication information is further configured to indicate that a state of the first measurement gap is a de-activated state.

In some possible implementations, the first measurement gap is a pre-configured measurement gap.

In a third aspect, the present disclosure provides a device for sending indication information, which can be configured to perform the steps executed by the network device in the above first aspect or any possible design thereof. The network device can implement various functions in each of the above methods in the form of a hardware structure, a software module or a combination of hardware structure and soft module.

When the device according to the third aspect is implemented with the software module, the device may include a transceiver module which may be configured to communication of a communication device.

When executing the steps in the above first aspect, the transceiver module is configured to send first indication information to a user equipment, the first indication information is configured to indicate that an association between a measurement object and a measurement gap can be changed.

In a fourth aspect, the present disclosure provides a device for receiving indication information, which can be configured to perform the steps executed by the user equipment in the above second aspect or any possible design thereof. The user equipment can implement various functions in each of the above methods in the form of a hardware structure, a software module or a combination of hardware structure and soft module.

When the device according to the fourth aspect is implemented with the software module, the device may include a transceiver module which may be configured to communication of a communication device.

When executing the steps in the above second aspect, the transceiver module is configured to receive first indication information sent by a network device, the first indication information is configured to indicate that an association between a measurement object and a measurement gap can be changed.

In a fifth aspect, the present disclosure provides a communication device including a processor and a memory, the memory stores a computer program, and the processor is configured to execute the computer program to implement the first aspect or any possible design thereof.

In a sixth aspect, the present disclosure provides a communication device including a processor and a memory, the memory stores a computer program, and the processor is configured to execute the computer program to implement the second aspect or any possible design thereof.

In a seventh aspect, the present disclosure provides a computer-readable storage medium with instructions (or a computer program or program) stored on that, when invoked and executed on a computer, cause the computer to implement the first aspect or any possible design thereof.

In an eighth aspect, the present disclosure provides a computer-readable storage medium with instructions (or a computer program or a program) stored on that, when invoked and executed on a computer, cause the computer to implement the second aspect or any possible design thereof.

It is to be understood that the above general description and the detailed descriptions that follow are exemplary and explanatory only and do not limit the present disclosure.

### BRIEF DESCRIPTION OF THE DRAWINGS

The accompanying drawings illustrated herein are used to provide a further understanding of embodiments of the present disclosure and form a part of the present disclosure, and the embodiments of the present disclosure and their illustrations are used to explain the embodiments of the present disclosure and do not constitute an undue limitation of the embodiments of the present disclosure.

The accompanying drawings herein, which are incorporated into and form a part of the specification, illustrate embodiments consistent with the embodiments of the present disclosure and are used with the specification to explain the principle of the embodiments of the present disclosure.

FIG. 1 is a schematic diagram of a wireless communication system architecture provided by an embodiment of the present disclosure;

FIG. 2 is a flowchart of a method for transmitting indication information according to an embodiment;

FIG. 3 is a flowchart of another method for transmitting indication information according to an embodiment;

FIG. 4 is a flowchart of a method for sending indication information according to an embodiment;

FIG. 5 is a flowchart of another method for sending indication information according to an embodiment;

FIG. 6 is a flowchart of another method for sending indication information according to an embodiment;

FIG. 7 is a flowchart of a method for receiving indication information according to an embodiment;

FIG. 8 is a block diagram of a device for sending indication information according to an embodiment;

FIG. 9 is a block diagram of a communication device according to an embodiment;

FIG. 10 is a block diagram of a device for receiving indication information according to an embodiment; and

FIG. 11 is a block diagram of a user equipment according to an embodiment.

### DETAILED DESCRIPTION

Embodiments of the present disclosure are further described in conjunction with the accompanying drawings and detailed implementations.

Embodiments will be described herein in detail, examples of which are represented in the accompanying drawings. When the following description relates to the accompanying drawings, the same numerals in the different figures indicate the same or similar elements unless otherwise indicated. The implementations described in the following embodiments do not represent all implementations consistent with the embodiments of the present disclosure. Rather, they are only examples of devices and methods consistent with some aspects of embodiments of the present disclosure.

The term used in the embodiments of the present disclosure is used solely for describing particular embodiments and is not intended to limit the embodiments of the present disclosure. The singular forms of “a,” “said,” and “the” used in the embodiments of the present disclosure and the appending claims are also intended to encompass the plural forms, unless clearly indicated otherwise in the context. It is also understood that the term “and/or” as used herein refers to and encompasses any or all possible combinations of one or more of the items listed in the associated list.

It is to be understood that while the terms first, second, third, etc. may be used in the embodiments of the present disclosure to describe various information, such information should not be limited to these terms. These terms are only used to distinguish the same type of information from one another. For example, without departing from the scope of the embodiments of the present disclosure, first information may also be referred to as second information, and similarly, the second information may be referred to as the first information. Depending on the context, the word “if” as used herein may be interpreted as “at the time of . . . ” or “when . . . ” or “in response to determining”.

Embodiments of the present disclosure will be described below, examples of which are shown in the accompanying drawings, and throughout which, the same or similar numerals indicate the same or similar elements. The embodiments described below with reference to the accompanying drawings are exemplary and are intended to explain the present disclosure but not to be construed as a limitation of the present disclosure.

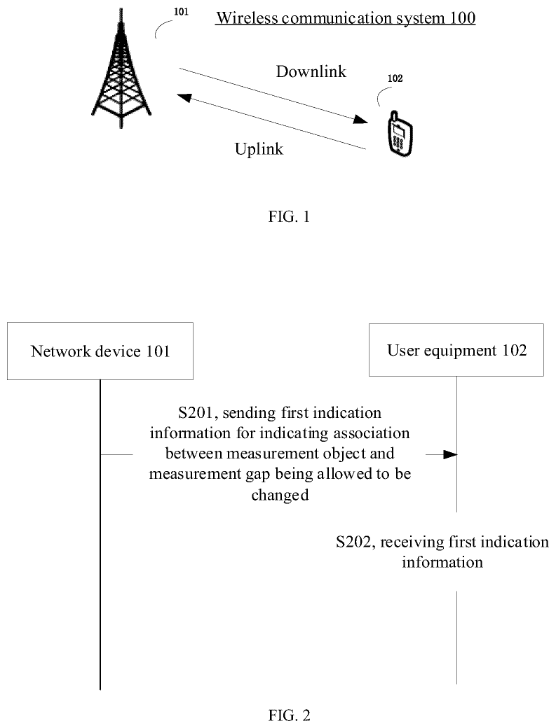

As shown in FIG. 1, a method for transmitting indication information provided by embodiments of the present disclosure may be applied to a wireless communication system 100, which may include a user equipment 102 and a network device 101. The user equipment 102 is configured to support carrier aggregation, and may be connected to a plurality of carrier units of the network device 101, including a primary carrier unit and one or more secondary carrier units.

It is to be understood that the above wireless communication system 100 may be applicable to both a low frequency scenario and a high frequency scenario. The application scenarios of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, a future evolved public land mobile network (PLMN) system or the like.

The user equipment 102 shown above may be a terminal, an access terminal, a terminal unit, a terminal station, a mobile station (MS), a remote station, a remote terminal, a mobile terminal, a wireless communication device, a terminal agent, a terminal device or the like. The user equipment 102 may have a wireless transceiver function, which can communicate (e.g., wirelessly) with one or more network devices 101 of one or more communication systems and receive network services provided by the network devices. The network device herein includes, but is not limited to, the network device 101 as shown.

The user equipment 102 may be a cellular telephone, a cordless telephone, a session initiation protocol (SIP) telephone, a wireless local loop (WLL) station, a personal digital assistant (PDA) device, a handheld device with wireless communication capabilities, a computing device or other processing device connected to a wireless modem, an in-vehicle device, a wearable device, a terminal device in a future 5G network, a terminal device in a future evolved PLMN network, and the like.

The network device 101 may be an access network device (or access network site). The access network device refers to a device that has a network access function, such as a radio access network (RAN) base station, and the like. The network device 101 may include a base station (BS), a base station, a wireless resource management device for controlling the base station, and the like. The network device 101 may include a relay station (relay device), an access point, a base station in future 5G network, a base station in future evolved PLMN network, a NR base station, or the like. The network device 101 may be a wearable device or an in-vehicle device. The network device 101 may also be a communication chip having a communication module.

For example, the network device 101 includes, but is not limited to, a next-generation base station (gnodeB, gNB) in 5G, an evolved node B (eNB) in an LTE system, a radio network controller (RNC), a node B (NB) in a WCDMA system, a wireless controller in a CRAN system, a base station controller (BSC), a base transceiver station (BTS) in a GSM system or a CDMA system, a home base station (e.g., home evolved nodeB, or home node B (HNB)), a baseband unit (BBU), a transmitting and receiving point (TRP), a transmitting point (TP), a mobile switching center or the like.

The pre-configured measurement gap (Pre-MG) has two states: an activated state and a de-activated state. The network device 101 may indicates changing of the activated and de-activated states of the pre-MG through signaling, alternatively, the user equipment 102 may dynamically change the activated and de-activated states of the Pre-MG at its own discretion.

In the related art, the network device 101 or the user equipment 102 determines the state of the Pre-MG by the following method. When a measurement object (MO) associated with the Pre-MG requires a measurement gap (MG), the Pre-MG is in the active state. When all MOs associated with the Pre-MG do not require the MG, the Pre-MG is in the de-activated state. When the Pre-MG is associated with a plurality of MOs, only one or some of the MOs require the MG, and the remaining MOs do not require the MG, for example, the Pre-MG is associated with MO1, MO2, MO3, and MO4, only the measurement of MO1 requires the measurement gap, and the measurements of MO2, MO3, and MO4 do not require the measurement gap, according to the determining method in the related art, the Pre-MG is in the activated state during the measurements of all MOs, and the network device may not schedule services during the measurements of the MO2, MO3 and MO4 that do not require the MG, resulting in throughput loss.

An embodiment of the present disclosure provides a method for transmitting indication information. Referring to FIG. 2, FIG. 2 illustrates a method for transmitting indication information according to an embodiment. As shown in FIG. 2, the method includes steps S201˜S202, which are specified below.

In step S201, the network device 101 sends first indication information to the user equipment 102, the first indication information being configured to indicate that an association between a measurement object and a measurement gap is allowed to be changed.

In step S202, the user equipment 102 receives the first indication information sent by the network device 101, the first indication information is configured to indicate that the association between the measurement object and the measurement gap can be changed.

In some possible implementations, the network device 101 sends to the user equipment 102 information for indicating whether the association between the MO and the measurement gap is allowed to be changed.

For example, when the network device 101 sends the first indication information to the user equipment 102, it indicates that the measurement gap to which the MO is associated may be changed, and when the network device 101 sends the information to the user equipment 102 regarding that the association between the MO and the measurement gap is not allowed to be changed, it indicates that the measurement gap to which the MO is associated may not be changed.

In some possible implementations, when the association between the MO and the measurement gap may be changed, a first type of MOs associated with the pre-configured measurement gap may be switched to be associated with another measurement gap, and the remaining second type of MOs associated with the pre-configured measurement gap is not switched. The first type of MOs is MO that requires the measurement gap, and the second type of MOs is MO that does not require the measurement gap. Therefore, the pre-configured measurement gap may be in the de-activated state when the first type of MOs is switched to be associated with another measurement gap.

In some possible implementations, steps S201˜S202 in the embodiment of the present disclosure may be performed after the network device 101 sends measurement configuration information. The measurement configuration information is used to configure the measurement gap, and a default MO is associated thereto.

In some possible implementations, steps S201˜S202 in the embodiment of the present disclosure may be performed when there is a triggering event which is configured to trigger reselection of an activated/de-activated state of the pre-configured measurement gap, i.e., to re-determine whether or not to change the state of the pre-configured measurement gap.

In the embodiment of the present disclosure, the network device 101 indicates to the user equipment 102 that it is allowed to change the association between the measurement object and the measurement gap by means of the first indication information sent, so as to facilitate more proper scheduling by changing the measurement gap corresponding to the measurement object.

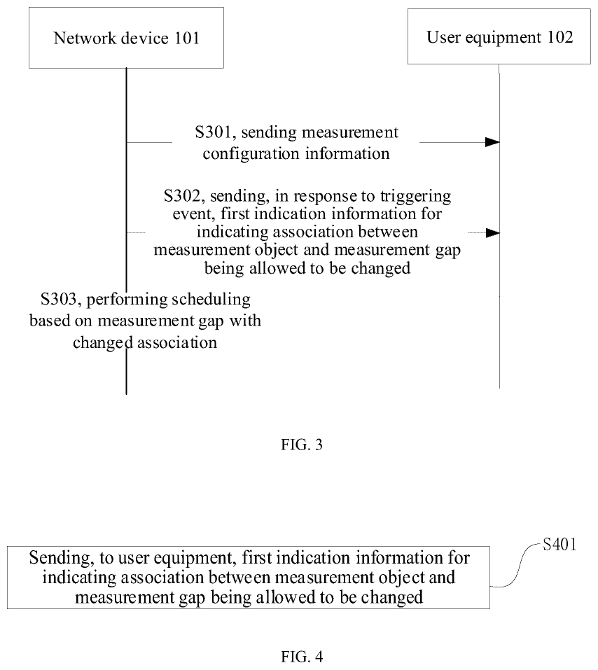

An embodiment of the present disclosure provides a method for transmitting the indication information. Referring to FIG. 3, FIG. 3 illustrates a method for transmitting indication information according to an embodiment. As shown in FIG. 3, the method includes steps S301˜S303, which is specified below.

In step S301, the network device 101 sends measurement configuration information to the user equipment 102, the measurement configuration information including at least one set of measurement gaps and a measurement object (MO) associated with each measurement gap.

In step S302, the network device 101 sends first indication information to the user equipment 102 in response to a triggering event, the first indication information being configured to indicate that an association between the measurement object and the measurement gap is allowed to be changed.

In step S303, the network device 101 performs scheduling based on the measurement gap with the changed association.

In some possible implementations, such as in a mobility measurement scenario such as radio resource management (RRM) measurement, the network device 101 may send measurement configuration information for the user equipment 102. The measurement configuration information includes at least one set of measurement gaps and may configure a measurement object (MO) to which each measurement gap is associated by default.

In some possible implementations, the network device 101 configures two sets of measurement gaps for the user equipment 102 in the measurement configuration information sent. The two sets of measurement gaps include a set of pre-configured measurement gaps (Pre-MGs), and a set of concurrent measurement gaps or network controlled small gaps (NCSGs).

In some possible implementations, the pre-configured measurement gap has two states: an activated state and a de-activated state. The activation and de-activation of the pre-configured measurement gap may be based on the control of the network device 101 or the autonomous judgement of the user equipment 102.

In some possible implementations, with respect to the concurrent measurement gap, on a per-UE basis, the network device 101 may simultaneously configure 2 sets of measurement gaps for the user equipment 102; and on a per-FR basis, the network device 101 may simultaneously configure up to 3 sets of measurement gaps for the user equipment 102, e.g., configuring 2 sets of measurement gaps for the UE under an FRI frequency band, and 1 set of measurement gaps under an FR2 frequency band. It is to be understood that the measurement gaps under different frequency bands may not have a conflict between time domain resources.

In some possible implementations, with respect to the NCSG, for the user equipment 102 with an idle receiving chain (Rx chain), the network device 101 may reduce the duration of interrupted data transmission between the user equipment 102 and the servicing cell by configuring the NCSG.

In some possible implementations, the triggering event includes one of:
the control by the network device 101; or
the autonomous judgement of the user equipment 102.

When any triggering event occurs, a reselection of the activated or de-activated
state of the pre-configured measurement gap is triggered, i.e., it re-determines whether to change the state of the pre-configured measurement gap.

For example, a first state of the pre-configured measurement gap is the activated state, and when any of the above triggering events occurs, a reselection of the state of the pre-configured measurement gap may be triggered, and the state after the reselection may be recorded as a second state of the pre-configured measurement gap. The second state may either remain the active state or become the de-activated state.

In some possible implementations, for the triggering event based on the control by the network device 101, the network device 101 may indicate to the user equipment 102 whether to change the state of the pre-configured measurement gap via radio resource control (RRC) signaling.

In some possible implementations, for the triggering event based on the autonomous judgement of the user equipment 102, the triggering event may also include one of:
basing on downlink control information (DCI), Timer, or RRC based active BWP switching;
activating or de-activating a secondary cell(s) (SCell(s));
adding or releasing any of MOs associated with the pre-configured measurement gap; or
adding or releasing or changing a secondary cell (SCell) in carrier aggregation (CA).

Based on any of the above triggering events, the user equipment 102 may reselect the activated/de-activated state of the pre-configured measurement gap, i.e., re-determine whether to change the state of the pre-configured measurement gap.

In some possible implementations, when re-determining whether to change the state of the pre-configured measurement gap, the following may be satisfied:
when an MO associated with the Pre-MG requires a measurement gap, the Pre-MG is in the active state; and
when all MOs associated with the Pre-MG do not require the MG, the Pre-MG is in the de-activated state.

In some possible implementations, when there is the triggering event, the network device 101 sends information to the user equipment 102 for indicating whether the measurement gap associated with the MO is allowed to be changed.

For example, when the network device 101 sends the first indication information to the user equipment 102, it indicates that the measurement gap to which the MO is associated may be changed, and when the network device 101 sends the information to the user equipment 102 regarding that the association between the MO and the measurement gap is not allowed to be changed, it indicates that the measurement gap to which the MO is associated may not be changed.

In some possible implementations, when the association between the MO and the measurement gap may be changed, a first type of MOs associated with the pre-configured measurement gap may be switched to be associated with another measurement gap, and the remaining second type of MOs associated with the pre-configured measurement gap is not switched. The first type of MOs is MO that requires the measurement gap, and the second type of MOs is MO that does not require the measurement gap. Therefore, the pre-configured measurement gap may be in the de-activated state when the first type of MOs is switched to be associated with another measurement gap.

To facilitate the understanding of the embodiments of the present disclosure, a specific example is set forth below.

The network device 101 sends the measurement configuration information for the user equipment 102, and the measurement configuration information configures a set of concurrent measurement gaps including a first measurement gap and a second measurement gap. The first measurement gap is the pre-configured measurement gap and the second measurement gap is the concurrent measurement gap or NCSG. The measurement configuration information further configures that the MOs associated with the first measurement gap include MO1, MO2, and MO3, and the MOs associated with the second measurement gap include MO5, MO6, and MO7, in which only MO1 is the MO of the first type, i.e., the MO that requires the measurement gap.

When the network device 101 sends the first indication information to the user equipment 102, it indicates that the association between the MO and the measurement gap may be changed. Therefore, the association of MO1 with the first measurement gap may be switched to the association with the second measurement gap, and thus none of the remaining MOs associated with the first measurement gap requires a measurement gap. The first measurement gap may be in the de-activated state, and during the first measurement gap, the network device 101 may schedule services to enhance throughput.

It is to be understood that when the network device 101 sends, to the user equipment 102, the information regarding that the association between the MO and the measurement gap is not allowed to be changed, the association between the MO and the measurement gap remains referenced to the indication of the measurement configuration information, and may not be changed.

In the embodiment of the present disclosure, by sending the first indication information, the network device 101 indicates, to the user equipment 102, that the association between the measurement object and the measurement gap is allowed to be changed, so that more proper scheduling may be performed by changing the measurement gap corresponding to the measurement object. For example, when the measurement gap associated with the first type of MO is changed, the pre-configured measurement gap may then be in the de-activated state, which reduces the time length of the pre-configured measurement gap in the activated state, thereby reducing the time length of the measurement gap caused by the measurement, and during the pre-configured measurement gap, the network device 101 may still carry out service scheduling in order to improve the throughput.

An embodiment of the present disclosure provides a method for sending indication information, which is performed by the network device 101. Referring to FIG. 4, FIG. 4 is a method for sending indication information according to an embodiment. As shown in FIG. 4, the method includes step S401.

Specifically, in step S401, the network device 101 sends first indication information to the user equipment 102, the first indication information being configured to indicate that an association between a measurement object and a measurement gap is allowed to be changed.

In some possible implementations, measurement configuration information sent by the network device 101 to the user equipment 102 is configured with the measurement gap and the measurement object associated thereto by default.

In some possible implementations, the measurement gap configured by the network device 101 includes a pre-configured measurement gap, and based on the first indication information, a first type of MOs with which the pre-configured measurement gap is associated by default may be switched to be associated with another measurement gap, so that the state of the pre-configured measurement gap may be adjusted. The first type of MOs is an MO that requires the measurement gap.

In the embodiment of the present disclosure, by sending the first indication information, the network device 101 indicates, to the user equipment 102, that the association between the measurement object and the measurement gap is allowed to be changed, so that more proper scheduling may be performed by changing the measurement gap corresponding to the measurement object.

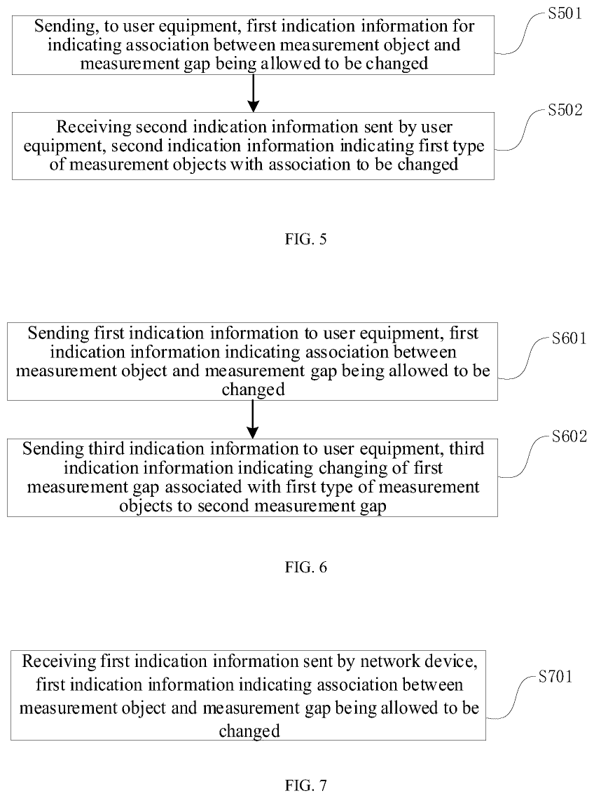

An embodiment of the present disclosure provides a method for sending indication information, which is performed by the network device 101. Referring to FIG. 5, FIG. 5 is a method for sending indication information according to an embodiment. As shown in FIG. 5, the method includes steps S501 to S502, which are specified below.

In step S501, the network device 101 sends first indication information to the user equipment 102, the first indication information being configured to indicate that an association between a measurement object and a measurement gap is allowed to be changed. In step S502, the network device 101 receives second indication information sent by the user equipment 102, the second indication information being configured to indicate a first type of measurement objects with the association to be changed.

In some possible implementations, the method of the present disclosure may be applicable in a scenario where the triggering event is based on the autonomous judgement of the user equipment 102.

In some possible implementations, after sending the first indication information, the network device 101 may receive the first type of MOs to be changed reported by the user equipment 102, so that the network device 101 may switch the measurement gap associated with the first type of MOs based on the first type of MOs reported by the user equipment 102.

In some possible implementations, the first type of MOs is an MO that requires the measurement gap.

In the embodiment of the present disclosure, the user equipment 102 reports the first type of MOs with the measurement gap to be changed, and the network device 101 may dynamically switch the measurement gap associated with the first type of MOs based on the first type of MOs reported by the user equipment 102.

An embodiment of the present disclosure provides a method for sending indication information, which is performed by the network device 101. The method includes steps S501˜S502′, which are specified below.

In step S501, the network device 101 sends first indication information to the user equipment 102, the first indication information being configured to indicate that an association between a measurement object and a measurement gap is allowed to be changed.

In step S502′, the network device 101 receives second indication information sent by the user equipment 102, the second indication information being configured to indicate changing of a first measurement gap associated with a first type of measurement objects to a second measurement gap.

In some possible implementations, the method of the present disclosure may be applicable in a scenario where the triggering event is based on the autonomous judgement of the user equipment 102.

In some possible implementations, the first measurement gap is a pre-configured measurement gap.

In some possible implementations, the second measurement gap is a concurrent measurement gap or an NCSG.

In some possible implementations, the first type of MOs is an MO that requires the measurement gap.

In the embodiment of the present disclosure, the user equipment 102 reports the first type of MOs and the measurement gap of the first type of MOs to be switched, so that the network device 101 may perform proper scheduling.

An embodiment of the present disclosure provides a method for sending indication information, which is performed by the network device 101. Referring to FIG. 6, FIG. 6 is a method for sending indication information according to an embodiment. As shown in FIG. 6, the method includes steps S601 to S602, which are specified below.

In step S601, the network device 101 sends first indication information to the user equipment 102, the first indication information being configured to indicate that an association between a measurement object and a measurement gap is allowed to be changed.

In step S602, the network device 101 sends third indication information to the user equipment 102, the third indication information being configured to indicate changing of a first measurement gap associated with a first type of measurement objects to a second measurement gap.

In some possible implementations, the method of the present disclosure may be applicable in a scenario where the triggering event is based on the control by the network device 101.

In some possible implementations, the first type of measurement objects is a measurement object requiring the measurement gap.

In some possible implementations, the first measurement gap is a pre-configured measurement gap.

In some possible implementations, the second measurement gap is a concurrent measurement gap or an NCSG.

In some possible implementations, the third indication information is further configured to indicate that a state of the first measurement gap is a de-activated state. For example, the third indication information indicates changing of the association of the first type of MOs with the first measurement gap to the association with the second measurement gap and indicates that the first measurement gap is in the de-activated state, so that the network device 101 may perform service scheduling during the first measurement gap.

In the embodiment of the present disclosure, the network device 101 may dynamically adjust the measurement gap associated with the first type of MOs, and may also indicate the state of the first measurement gap after reselection, which is conducive to proper scheduling.

An embodiment of the present disclosure provides a method for sending indication information, which is performed by the network device 101. The method includes step S401′.

Specifically, in step S401′, the network device 101 sends wireless resource control (RRC) signaling to the user equipment 102, the RRC signaling including the first indication information.

In the embodiment of the present disclosure, the network device 101 sends the first indication information to the user equipment via the RRC signaling to indicate that the measurement gap associated with the measurement object may be changed.

An embodiment of the present disclosure provides a method for sending indication information which is performed by the network device 101. The method includes step S401″.

Specifically, in step S401″, the network device 101 sends the first indication information to the user equipment 102 in response to a triggering event, the triggering event being configured to trigger reselection of an activated or de-activated state of the measurement gap. In some possible implementations, the triggering event includes one of:
the control by the network device 101; or
the autonomous judgement of the user equipment 102.

When any triggering event occurs, a reselection of the activated or de-activated
state of the pre-configured measurement gap is triggered, i.e., it re-determines whether to change the state of the pre-configured measurement gap.

For example, a first state of the pre-configured measurement gap is the activated state, and when any of the above triggering events occurs, a reselection of the state of the pre-configured measurement gap may be triggered, and the state after the reselection may be recorded as a second state of the pre-configured measurement gap. The second state may either remain the active state or become the de-activated state.

In some possible implementations, for the triggering event based on the control by the network device 101, the network device 101 may indicate to the user equipment 102 whether to change the state of the pre-configured measurement gap via radio resource control (RRC) signaling.

In some possible implementations, for the triggering event based on the autonomous judgement of the user equipment 102, the triggering event may also include one of:
basing on downlink control information (DCI), Timer, or RRC based active BWP switching;
activating or de-activating a secondary cell(s) (SCell(s));
adding or releasing any of MOs associated with the pre-configured measurement gap; or
adding or releasing or changing a secondary cell (SCell) in carrier aggregation (CA).

Based on any of the above triggering events, the user equipment 102 may reselect the activated/de-activated state of the pre-configured measurement gap, i.e., re-determine whether to change the state of the pre-configured measurement gap.

An embodiment of the present disclosure provides a method for sending indication information which is performed by the network device 101. The method includes steps S401˜S402, which are specified below.

In step S401, the network device 101 sends first indication information to the user equipment 102, the first indication information being configured to indicate that an association between a measurement object and a measurement gap is allowed to be changed.

In step S402, the network device 101 performs scheduling based on the measurement gap with the association changed.

In some possible implementations, the network device 101 may send the first indication information in response to a triggering event.

In some possible implementations, in a scenario where the triggering event is based on the autonomous judgement of the user equipment 102, the network device 101 may receive second indication information sent by the user equipment 102 after sending the first indication information. The second indication information may indicate the first type of MOs, or indicate the first type of MOs and the measurement gap to be switched.

In some possible implementations, in a scenario where the triggering event is based on the control by the network device 101, the network device 101, after sending the first indication information, may also send third indication information to the user equipment 102. The third indication information is configured to indicate changing of a first measurement gap associated with the first type of MOs to a second measurement gap.

In some possible implementations, the first type of MOs is an MO that requires a measurement gap, and the first measurement gap is a pre-configured measurement gap.

In the embodiment of the present disclosure, when the first type of MOs is switched to be associated with the second measurement gap, the MOs associated with the first measurement gap are all MOs that do not require the measurement gap, and thus the first measurement gap may then be in the de-activated state. Therefore, the time length occupied by the measurement gap is reduced, the time length for scheduling by the network device 101 is increased, and scheduling may be performed during the first measurement gap, thereby improving throughput performance.

An embodiment of the present disclosure provides a method for receiving indication information, which is performed by the user equipment 102. Referring to FIG. 7, FIG. 7 is a method for receiving indication information according to an embodiment. As shown in FIG. 7, the method includes step S701.

Specifically, in step S701, the user equipment 102 receives first indication information sent by the network device 101, the first indication information being configured to indicate that an association between a measurement object and a measurement gap is allowed to be changed.

In the embodiment of the present disclosure, the user equipment 102 obtains, according to the first indication information sent by the network device 101, that the association between the measurement object and the measurement gap is allowed to be changed, so that proper scheduling from the network device 101 may be received by changing the measurement gap corresponding to the measurement object.

An embodiment of the present disclosure provides a method for receiving indication information, which is performed by the user equipment 102. The method includes steps S701 and S702, which are specified below.

In step S701, the user equipment 102 receives first indication information sent by the network device 101, the first indication information being configured to indicate that an association between a measurement object and a measurement gap is allowed to be changed.

In step S702, the user equipment 102 sends second indication information to the network device 101 in response to receiving the first indication information, the second indication information being configured to indicate a measurement object with the association to be changed, or to indicate changing of a first measurement gap associated with a first type of measurement objects to a second measurement gap.

In some possible implementations, the method of the present disclosure may be applicable in a scenario where the triggering event is based on autonomous judgement of the user equipment 102.

In some possible implementations, the first type of MOs is an MO that requires the measurement gap.

In some possible implementations, the first measurement gap is a pre-configured measurement gap.

In some possible implementations, the second measurement gap is a concurrent measurement gap or an NCSG.

In the embodiment of the present disclosure, the user equipment 102 may report the first type of MOs with the measurement gap to be changed, or report the first type of MOs and the measurement gap of the first type of MOs to be switched, so that the network device 101 may perform proper scheduling.

An embodiment of the present disclosure provides a method for receiving indication information, which is performed by the user equipment 102.

The method includes steps S701 and S702-1, which are specified below.

In step S701, the user equipment 102 receives first indication information sent by the network device 101, the first indication information being configured to indicate that an association between a measurement object and a measurement gap is allowed to be changed.

In step S702-1, the user equipment 102 sends RRC signaling to the network device, the RRC signaling including second indication information.

Alternatively, the method includes steps S701˜S702-2, which are specified below.

In step S701, the user equipment 102 receives first indication information sent by the network device 101, the first indication information being configured to indicate that an association between a measurement object and a measurement gap is allowed to be changed.

In step S702-2, the user equipment 102 sends media access control (MAC) signaling to the network device, the MAC signaling including the second indication information.

In some possible implementations, the MAC signaling may be media access control control element (MAC CE) signaling.

Alternatively, the method includes steps S701 to S702-3, which are specified below.

In step S701, the user equipment 102 receives first indication information sent by the network device 101, the first indication information being configured to indicate that an association between a measurement object and a measurement gap is allowed to be changed.

In step S702-3, the user equipment 102 sends uplink control information (UCI) to the network device, the UCI including the second indication information.

In the embodiment of the present disclosure, the user equipment 102 may send the second indication information in three ways, so as to report this second indication information to the network device 101.

An embodiment of the present disclosure provides a method for receiving indication information, which is performed by the user equipment 102. The method includes steps S701 and S703, which are specified below.

In step S701, the user equipment 102 receives first indication information sent by the network device 101, the first indication information being configured to indicate that an association between a measurement object and a measurement gap is allowed to be changed.

In step S703, the user equipment 102 receives third indication information sent by the network device 101, the third indication information being configured to indicate changing of the first measurement gap associated with the first type of measurement objects to the second measurement gap.

In some possible implementations, the method of the present disclosure may be applicable in a scenario where the triggering event is based on the control by the network device 101.

In some possible implementations, the first measurement gap is a pre-configured measurement gap.

In some possible implementations, the first type of MOs is an MO that requires the measurement gap.

In some possible implementations, the third indication information is further used to indicate that a state of the first measurement gap is a de-activated state.

In the embodiment of the present disclosure, the user equipment 102 obtains, according to the third indication information, the measurement gap associated with the first type of MOs dynamically adjusted by the network device 101.

To facilitate understanding of the embodiments of the present disclosure, a specific example is set forth below.

The network device 101 configures a set of concurrent measurement gaps via RRC signaling IE MeasGapConfig, and the set of concurrent measurement gaps includes a first measurement gap and a second measurement gap. The first measurement gap is a pre-configured measurement gap and the second measurement gap is a concurrent measurement gap or an NCSG. The measurement configuration information further configures that the MOs associated with the first measurement gap include MO1, MO2, MO3, and MO4, and the MOs associated with the second measurement gap include MO5, MO6, MO7, and MO8.

Among the MOs associated with the first measurement gap, MO1 and MO2 are MOs of the second type, i.e., MOs that do not require the measurement gap; and MO3 and MO4 are MOs of the first type, i.e., MOs that require the measurement gap.

When there is the triggering event, the network device 101 may send the first indication information to the user equipment 102 to indicate that the association between the MO and the measurement gap may be dynamically changed or switched.

In response to the triggering event, the state of the first measurement gap will be reselected.

In a scenario where the triggering event is based on the control by the network device 101, the network device 101 reselects the state of the first measurement gap, and sends the third indication information to the user equipment 102. The third indication information configures the first measurement gap to be de-activated and indicates associating of MO3 and MO4 with the second measurement gap.

In a scenario where the triggering event is based on autonomous judgement of the user equipment 102, the user equipment 102 autonomously determines the state of the first measurement gap to be reselected, and sends the second indication information to the network device 101. The second indication information may be information only indicating the first type of MOs, for example, indicating MO3 and MO4; or indicates associating of MO3 and MO4 with the second measurement gap.

In this example, by switching the measurement gap associated with the first type of MOs, the time length of the pre-configured measurement gap in the activated state may be reduced, thereby reducing the time length of the measurement gap caused by the measurement, and during the pre-configured measurement gap, the network device 101 may still carry out service scheduling in order to improve the throughput.

Based on the same concept as the above method embodiments, an embodiment of the present disclosure also provides a device for sending indication information, which may have the function of the network device 101 in the above method embodiments and may be configured to perform the steps performed by the network device 101 provided by the above method embodiments. The function may be implemented by hardware, or by software, or by hardware executing corresponding software. The hardware or software includes one or more modules corresponding to the function described above.

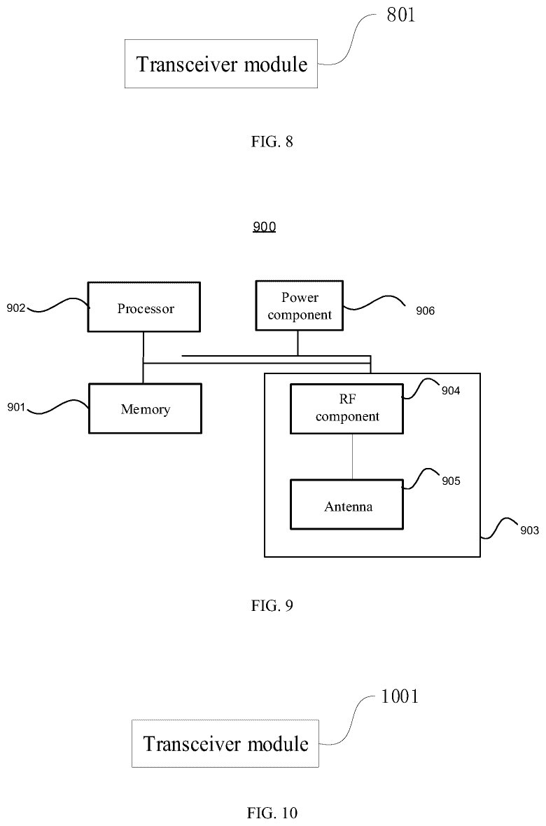

In a possible implementation, the device 800 as shown in FIG. 8 may act as the network device 101 involved in the above method embodiments and perform the steps performed by the network device 101 in the above method embodiments. As shown in FIG. 8, the device 800 may include a transceiver module 801, and the transceiver module 801 may support communication of a communication device.

When performing the steps performed by the network device 101, the transceiver module 801 is configured to send first indication information to a user equipment, the first indication information being configured to indicate that an association between a measurement object and a measurement gap is allowed to be changed.

In some possible implementations, the transceiver module 801 is further configured to receive second indication information sent by the user equipment, the second indication information being configured to indicate a measurement object with the association to be changed.

In some possible implementations, the transceiver module 801 is further configured to receive second indication information sent by the user equipment, the second indication information being configured to indicate changing of a first measurement gap associated with a first type of measurement objects to a second measurement gap.

In some possible implementations, the transceiver module 801 is further configured to send third indication information to the user equipment, the third indication information being configured to indicate changing of a first measurement gap associated with a first type of measurement objects to a second measurement gap.

In some possible implementations, the third indication information is configured to indicate that a state of the first measurement gap is a de-activated state.

In some possible implementations, the first type of measurement objects is a measurement object requiring the measurement gap.

In some possible implementations, the first measurement gap is a pre-configured measurement gap.

In some possible implementations, the transceiver module 801 is further configured to send wireless resource control (RRC) signaling to the user equipment, the RRC signaling including the first indication information.

In some possible implementations, the transceiver module 801 is further configured to send the first indication information to the user equipment in response to a triggering event, the triggering event being configured to trigger reselection of an activated or de-activated state of the measurement gap.

In some possible implementations, the device 800 further includes a processing module coupled to the transceiver module 801. The processing module is configured to perform scheduling based on the measurement gap with the association changed.

When the communication device is the network device 101, the structure thereof may also be shown in FIG. 9. The structure of the communication device is illustrated by using a base station as an example. As shown in FIG. 9, the communication device 900 includes a memory 901, a processor 902, a transceiver component 903, and a power component 906. The memory 901 is coupled to the processor 902 and may be used to store programs and data necessary for the communication device 900 to implement various functions. The processor 902 is configured to support the communication device 900 to perform the corresponding functions in the method described above, and the functions may be realized by calling programs stored in the memory 901. The transceiver component 903 may be a wireless transceiver that may be used to support the communication device 900 to receive signal and/or data and send signal and/or data via a wireless radio. The transceiver component 903 may also be referred to as a transceiver unit or a communication unit. The transceiver component 903 may include a radio frequency (RF) component 904 and one or more antennas 905. The RF component 904 may be a remote radio unit (RRU), which may be specifically used for the transmission of RF signals and the conversion between RF signals and baseband signals. The one or more antennas 905 may be used specifically for radiation and reception of RF signals.

When the communication device 900 needs to send data, the processor 902 may perform baseband processing on the data to be sent and then output a baseband signal to a RF unit. The RF unit performs RF processing on the baseband signal, and then transmits a RF signal in the form of electromagnetic waves through the antenna. When there is data sent to the communication device 900, the RF unit receives the RF signal through the antenna, converts the RF signal into a baseband signal, and outputs the baseband signal to the processor 902, which converts the baseband signal into data and processes the data.

Based on the same concept as the above method embodiments, an embodiment of the present disclosure also provides a device for receiving indication information that may have the function of the user equipment 102 in the above method embodiments and may be used to perform the steps performed by the user equipment 102 provided by the above method embodiments. The function may be implemented by hardware, or by software, or by hardware executing corresponding software. The hardware or software includes one or more modules corresponding to the function described above.

In a possible implementation, the communication device 1000 as shown in FIG. 10 may act as the user equipment 102 involved in the above method embodiments and perform the steps performed by the user equipment 102 in the above method embodiments. As shown in FIG. 10, the communication device 1000 may include a transceiver module 1001, and the transceiver module 1001 may support communication of the communication device. The transceiver module 1001 may have a wireless communication function, for example, it may communicate wirelessly with other communication devices via wireless radio.

When performing the steps performed by the user equipment 102, the transceiver module 1001 is configured to receive first indication information sent by a network device, the first indication information being configured to indicate that an association between a measurement object and a measurement gap is allowed to be changed.

In some possible implementations, the transceiver module 1001 is further configured to send second indication information to the network device in response to receiving the first indication information, the second indication information being configured to indicate a measurement object with the association to be changed, or to indicate changing of a first measurement gap associated with a first type of measurement objects to a second measurement gap.

In some possible implementations, the transceiver module 1001 is further configured to perform one of:
sending RRC signaling to the network device, the RRC signaling including the second indication information;
sending media access control (MAC) signaling to the network device, the MAC signaling including the second indication information; or
sending uplink control information (UCI) to the network device, the UCI including the second indication information.

In some possible implementations, the transceiver module 1001 is further configured to receive third indication information sent by the network device, the third indication information being configured to indicate changing of the first measurement gap associated with the first type of measurement objects to the second measurement gap.

In some possible implementations, the third indication information is further configured to indicate that a state of the first measurement gap is a de-activated state.

In some possible implementations, the first measurement gap is a pre-configured measurement gap.

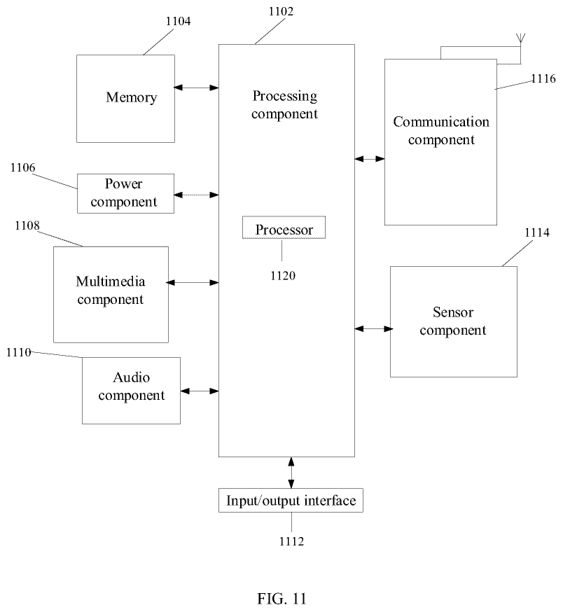

When the communication device is the user equipment 102, the structure thereof may also be as shown in FIG. 11. Referring to FIG. 11, the device 1100 may include one or more of a processing component 1102, a memory 1104, a power component 1106, a multimedia component 1108, an audio component 1110, an input/output (I/O) interface 1112, a sensor component 1114, and a communication component 1116.

The processing component 1102 generally controls the overall operations of the device 1100, such as operations associated with display, telephone calls, data communications, camera operations, and recording operations. The processing component 1102 may include one or more processors 1120 to execute instructions to complete all or part of the steps of the foregoing method. In addition, the processing component 1102 may include one or more modules to facilitate interaction between the processing component 1102 and other components. For example, the processing component 1102 may include a multimedia module to facilitate the interaction between the multimedia component 1108 and the processing component 1102.

The memory 1104 is configured to store various types of data to support the operation at the device 1100. Examples of these data include instructions for any application or method operating on the device 1100, contact data, phone book data, messages, pictures, videos and the like. The memory 1104 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 1106 provides power to various components of the device 1100. The power component 1106 may include a power management system, one or more power supplies, and other components associated with generating, managing, and distributing power for the device 1100.

The multimedia component 1108 includes a screen that provides an output interface between the device 1100 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of the touch or slide action, but also detect the duration and pressure related to the touch or slide operation. In some embodiments, the multimedia component 1108 includes a front camera and/or a rear camera. When the device 1100 is in an operation mode, such as a shooting mode or a video mode, the front camera and/or the rear camera can receive external multimedia data. Each of the front camera and rear camera may be a fixed optical lens system or have focal length and optical zoom capabilities.

The audio component 1110 is configured to output and/or input audio signals. For example, the audio component 1110 includes a microphone (MIC), and when the device 1100 is in an operation mode, such as a call mode, a recording mode, and a voice recognition mode, the microphone is configured to receive an external audio signal. The received audio signal can be further stored in the memory 1104 or sent via the communication component 1116. In some embodiments, the audio component 1110 further includes a speaker for outputting audio signals.

The I/O interface 1112 provides an interface between the processing component 1102 and a peripheral interface module. The above-mentioned peripheral interface module may be a keyboard, a click wheel, a button, and the like. These buttons may include but are not limited to home button, volume button, start button, and lock button.

The sensor component 1114 includes one or more sensors for providing the device 1100 with various aspects of state evaluation. For example, the sensor component 1114 can detect the on/off status of the device 1100 and the relative positioning of components. For example, the component is a display and keypad of the device 1100. The sensor component 1114 can also detect the position change of the device 1100 or a component of the device 1100, the presence or absence of contact between the user and the device 1100, the orientation or acceleration/deceleration of the device 1100, and the temperature change of the device 1100. The sensor component 1114 may include a proximity sensor configured to detect the presence of nearby objects when there is no physical contact. The sensor component 1114 may also include a light sensor, such as a CMOS or CCD image sensor, for use in imaging applications. In some embodiments, the sensor component 1114 may also include an acceleration sensor, a gyroscope sensor, a magnetic sensor, a pressure sensor, or a temperature sensor.

The communication component 1116 is configured to facilitate wired or wireless communication between the device 1100 and other devices. The device 1100 can access a wireless network based on a communication standard, such as WiFi, 2G, 3G, 4G, 5G, or a combination thereof. In an embodiment, the communication component 1116 receives a broadcast signal or broadcast related information from an external broadcast management system via a broadcast channel. In an embodiment, the communication component 1116 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the device 1100 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

An embodiment also provides a non-transitory computer-readable storage medium including instructions, such as the memory 1104 including instructions, and the instructions may be executed by the processor 1120 of the device 1100 to complete the foregoing method. For example, the non-transitory computer-readable storage medium may be ROM, random access memory (RAM), CD-ROM, magnetic tape, floppy disk, optical data storage device and the like.

A person skilled in the art may easily conceive of other implementations of the embodiments of the present disclosure upon consideration of the specification and practice of the invention disclosed herein. The present disclosure is intended to cover any variations, uses, or adaptations of the embodiments of the present disclosure that follow the general principle of the embodiments of the present disclosure and include the common knowledge or conventional technical means in the technical field not disclosed by the present disclosure. The specification and embodiments are to be regarded as exemplary only, with the true scope and spirit of the present disclosure being indicated by the following claims.

It is to be understood that the embodiments of the present disclosure are not limited to the precise structures described above and illustrated in the accompanying drawings, and that various modifications and changes may be made without departing from the scope thereof. The scope of the embodiments of the present disclosure is limited only by the appended claims.

In the embodiments of the present disclosure, by sending the first indication information, the network device indicates, to the user equipment, that the association between the measurement object and the measurement gap is allowed to be changed, so that more proper scheduling may be performed by changing the measurement gap corresponding to the measurement object.

1. A method for sending indication information performed by a network device, comprising:
sending first indication information to a user equipment, the first indication information being configured to indicate that an association between a measurement object and a measurement gap is allowed to be changed.

2. The method according to claim 1, further comprising:
receiving second indication information sent by the user equipment, the second indication information being configured to indicate a first type of measurement objects with the association to be changed.

3. The method according to claim 1, further comprising:
receiving second indication information sent by the user equipment, the second indication information being configured to indicate changing of a first measurement gap associated with a first type of measurement objects to a second measurement gap.

4. The method according to claim 1, further comprising:
sending third indication information to the user equipment, the third indication information being configured to indicate changing of a first measurement gap associated with a first type of measurement objects to a second measurement gap.

5. The method according to claim 4, wherein
the third indication information is configured to indicate that a state of the first measurement gap is a de-activated state.

6. The method according to claim 2, wherein the first type of measurement objects is a measurement object requiring the measurement gap.

7. The method according to claim 3, wherein the first measurement gap is a pre-configured measurement gap.

8. The method according to claim 1, wherein sending the first indication information to the user equipment comprises:
sending wireless resource control (RRC) signaling to the user equipment, the RRC signaling comprising the first indication information.

9. The method according to claim 1, wherein sending the first indication information to the user equipment comprises:
sending the first indication information to the user equipment in response to a triggering event, the triggering event being configured to trigger reselection of an activated or de-activated state of the measurement gap.

10. The method according to claim 1, further comprising:
performing scheduling based on the measurement gap with the association changed.

11. A method for receiving indication information performed by a user equipment (UE), the method comprising:
receiving first indication information sent by a network device, the first indication information being configured to indicate that an association between a measurement object and a measurement gap is allowed to be changed.

12. The method according to claim 11, further comprising:
sending second indication information to the network device in response to receiving the first indication information, the second indication information being configured to indicate a first type of measurement objects with the association to be changed, or to indicate changing of a first measurement gap associated with the first type of measurement objects to a second measurement gap.

13. The method according to claim 12, wherein sending the second indication information to the network device comprises one of:
sending RRC signaling to the network device, the RRC signaling comprising the second indication information;
sending media access control (MAC) signaling to the network device, the MAC signaling comprising the second indication information; or
sending uplink control information (UCI) to the network device, the UCI comprising the second indication information.

14. The method according to claim 13, further comprising:
receiving third indication information sent by the network device, the third indication information being configured to indicate changing of the first measurement gap associated with the first type of measurement objects to the second measurement gap.

15. The method according to claim 14, wherein the third indication information is further configured to indicate that a state of the first measurement gap is a de-activated state.

16. The method according to claim 12, wherein the first measurement gap is a pre-configured measurement gap.

17-22. (canceled)

23. A network device, comprising:
a memory storing instructions; and
one or more processors communicatively coupled to the memory;
wherein the instructions when collectively executed by the one or more processors causes the network device to:
send first indication information to a user equipment, the first indication information being configured to indicate that an association between a measurement object and a measurement gap is allowed to be changed.

24. The network device according to claim 23, wherein the instruction when collectively executed by the one or more processors further causes the network device to:
receive second indication information sent by the user equipment, the second indication information being configured to indicate a first type of measurement objects with the association to be changed.

25. The network device according to claim 23, wherein the instruction when collectively executed by the one or more processors causes the network device to:
receive second indication information sent by the user equipment, the second indication information being configured to indicate changing of a first measurement gap associated with a first type of measurement objects to a second measurement gap, or to indicate changing of the first measurement gap associated with the first type of measurement objects to a second measurement gap.

26. A communication device comprising:
a memory storing instructions; and
one or more processors communicatively coupled to the memory,
wherein the instructions when collectively executed by the one or more processors cause the communication device, when executed by the processor, cause the communication device to act as the UE and perform the method according to claim 11.
